(19) United States
(12) Patent Application Publication
(10) Pub. No.: US 2017/0130928 A1
(43) Pub. Date: May 11, 2017

(54) DUAL-FUNCTION LIGHTING DEVICE WITH THREE-DIMENSIONAL EFFECT, NOTABLY FOR MOTOR VEHICLES, AND LIGHT INCLUDING A LIGHTING DEVICE OF THIS KIND

(71) Applicant: Valeo Vision, Bobigny Cedex (FR)

(72) Inventor: Christophe Duval, Pontault-Combault (FR)

(21) Appl. No.: 15/340,241

(22) Filed: Nov. 1, 2016

(30) Foreign Application Priority Data
Nov. 5, 2015 (FR) 1560598

(51) Int. Cl. F21S 8/10; F21V 8/00

(52) U.S. Cl. CPC F21S 48/20; F21S 48/217; F21S 48/215; F21S 48/23; G02B 6/0038; F21S 48/2243; F21S 48/2268

(57) ABSTRACT

A dual-function lighting device for motor vehicles comprising a first light source, a second light source, a light reflector and a semi-reflecting mirror, the device being configured so that the first source is adapted to emit toward the mirror a first light beam so that a first fraction of the first beam is transmitted by the mirror at an output of the device and a second fraction of the first beam is reflected toward the reflector, the reflector being adapted to reflect the second fraction toward the mirror to duplicate the luminous pattern of the first beam at the output of the device, the device being further configured so that the second source is adapted to emit a second beam oriented along the same optical axis (Ox) as the first beam at the output of the device, one of the first or second light sources being an area source and the other source being a point source.

The present invention concerns a dual-function lighting device with three-dimensional effect, notably for motor vehicles. The invention also concerns a light including a lighting device of this kind.

Motor vehicle lights, generally situated at the rear of the vehicle, are lighting devices that comprise one or more light sources and an outer lens that closes the light. Simply put, the light source emits light rays to form a light beam that is directed toward the outer lens in order to produce a lighted area that transmits the light to the outside of the vehicle. The color of the lighted area is characteristic of the function or type of light. Thus it is known that a white lighted area indicates that the light is a reversing light, that an amber lighted area is a turn indicator, and that a red lighted area is a rear light or stop light, the stop light being of a more intense color. There also exist red fog lights, the intensity of which is even greater so as to be visible under difficult climatic conditions, such as fog, heavy rain or snow. In addition to the color, these lights must conform to regulations in respect of intensity and visibility in particular.

Thus the rear of a vehicle includes a plurality of outer lenses, each outer lens having a color specific to each function. The light source has a luminous intensity chosen relative to the type of light. Each of the outer lenses being moreover illuminated by at least one different light source, the number of lighting devices on the vehicle is multiplied. The light sources are light-emitting diodes, for example. The configuration and the positioning of the sources and the outer lenses are therefore limited.

To solve this problem, there exist devices that make it possible to combine a plurality of functions in one light, notably using a single outer lens onto which distinct light sources project different light beams, each beam corresponding to a different light function.

Also known are devices capable of producing three-dimensional visual lighting effects. The document EP1916471 shows a device that combines light sources with a semi-reflecting mirror and a reflector. The beams produced by the sources are projected onto the semi-reflecting mirror, which transmits a first part of the light beam on the downstream side to the outside of the device and reflects the second part toward the reflector situated on the upstream side of the mirror. The reflected part is reflected by the reflector onto the semi-reflecting mirror in an offset manner, in order to be divided again there into a part transmitted to the outside and another part reflected toward the reflector, and this occurs in an iterative manner. Thus the beam is subjected to multiple splitting and reflection between the mirror and the reflector to produce multiple repetitions of the lighting pattern of the light source. This produces a visual effect at the output of the device that gives an impression of three-dimensional depth of the light.

Now, at present there does not exist any device capable of combining a plurality of functions where at least one of said functions has a three-dimensional effect at the output of the device.

The object of the invention is to remedy this lack, and the invention aims to provide a lighting device configured to simplify the number of lights on a vehicle and to offer new disposition and design possibilities in order to able to produce one or more three-dimensional visual effects.

To this end, the invention relates to a dual-function lighting device, notably for motor vehicles, comprising a first light source and a second light source, a light reflector and a semi-reflecting mirror, the device being configured so that the first source is adapted to emit toward the semi-reflecting mirror a first light beam so that a first fraction of the first beam is transmitted by the mirror at the output of the device and a second fraction of the first beam is reflected toward the reflector, the reflector being adapted to reflect the second fraction toward the semi-reflecting mirror to duplicate the luminous pattern of the first light beam at the output of the device, the device being further configured so that the second source is adapted to emit a second light beam oriented along substantially the same optical axis as the first beam at the output of the device, one of the two light sources being an area light source and the other source being a substantially point light source.

Accordingly, with a single device, it is possible on the one hand to use the first source for a first function with a three-dimensional effect and on the other hand to use the second source for a second function.

Thanks to the invention, the useable area necessary for each light function on the vehicle is reduced because the two beams are projected along substantially the same optical axis and therefore through a single outer lens. Particular visual effects can also be created by combining the two functions simultaneously.

According to various embodiments of the invention, separately or in combination:

the first light source is the point source and the second light source is the area source,

the area source is an organic light-emitting diode having a semi-reflecting area of the rear face, that layer defining the semi-reflecting mirror of the device,

the semi-reflecting layer is formed by a coating deposited on a rear electrode of the OLED,

the semi-reflecting layer is formed by a rear electrode of the OLED,

the point source, the area source and the reflector are disposed relative to one another so that the first fraction and at least part of the reflected second fraction pass through the area source,

the reflector is disposed on the upstream side of the area source, the area source being disposed at the output of the device,

the reflector is convex and the OLED is plane,

the area source is convex,

the area source is an organic light-emitting diode having a reflecting layer on the rear face, that layer defining the reflector of the device,

the semi-reflecting mirror is arranged on the downstream side of the area source,

the area source, the reflector and the mirror are disposed relative to one another so that at least a part of the second beam passes through the semi-reflecting mirror,

the semi-reflecting mirror is convex and the OLED is plane,

the first light source is the area source and the second light source is the point source,

the area source is an organic light-emitting diode having a reflecting layer on the rear face, the reflecting layer defining the reflector of the device,

said device comprises a light guide arranged on the downstream side of the area source, the light guide having a semi-transparent rear face defining the semi-reflecting mirror of the device, the light guide being configured to guide the second light beam from an entry face to an exit face of the guide,

the light guide has decoupling patterns on the rear face so as to deflect the second light beam toward the exit face, the exit face being substantially parallel to the rear face,

the point source is a light-emitting diode with no organic layer,

said device is configured so that the second fraction of the first beam is subjected to multiple splitting in transmission and reflection between the reflector and the semi-reflecting mirror so as to reproduce multiple times the light pattern of the first beam at the output of the device,

the semi-reflecting mirror and the reflector are substantially parallel,

they are substantially parallel, whether the mirror and the reflector are plane, or the mirror and the reflector are curved,

if they are curved, the mirror and the reflector have identical profiles,

the semi-reflecting mirror has a reflection coefficient of at least 5%, preferably 40%, or even 50%,

the reflector has a reflection coefficient of at least 70%,

the semi-reflecting mirror is arranged at the output of the device,

the first light beam corresponds to a first predetermined statutory function of a motor vehicle light,

the second light beam corresponds to a second predetermined statutory function of a motor vehicle light,

the first light beam and the second light beam emitted simultaneously correspond to a third predetermined statutory function of a motor vehicle light,

the area light source is a light source having an emitting area the dimensions of which are significantly greater than the thickness of said area source,

the substantially point source is a source having an emitting area the dimensions of which are negligible relative to those of the area source.

The invention also relates to a motor vehicle light, notably for use at night, comprising a dual effect lighting device with three-dimensional effect.

The invention will be better understood in the light of the following description given by way of illustration only and not in any way intended to limit the invention, accompanied by the appended drawings, in which:

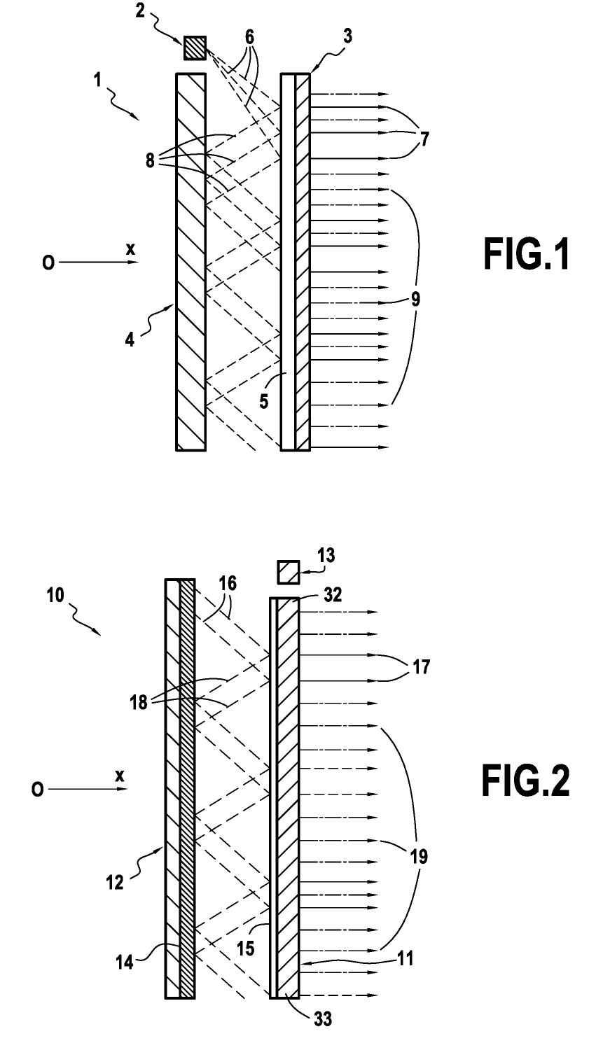

FIG. 1 is a diagrammatic sectional view of a dual-function lighting device in accordance with a first embodiment,

FIG. 2 is a diagrammatic sectional view of a dual-function lighting device in accordance with a second embodiment,

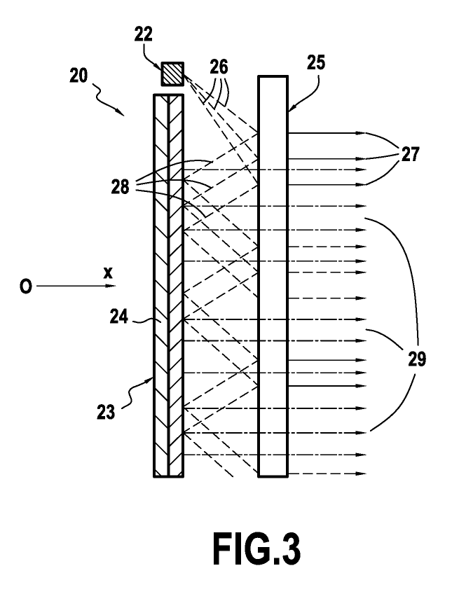

FIG. 3 is a diagrammatic sectional view of a dual-function lighting device in accordance with a third embodiment.

For the purposes of the following description, an area source is defined as an area emitting light of preferably at least 1 cm² and up to a few tens of cm², or even hundreds of cm², and a point source as an area emitting light of preferably less than 1 cm². The area source is preferably a light source having an emitting area the dimensions of which are significantly greater than the thickness of said area source. The substantially point source is preferably a source having an emitting area the dimensions of which are negligible compared to those of the area source.

In the three embodiments of FIGS. 1, 2 and 3 the dual-function lighting device, notably for a motor vehicle light, comprises a first light source 2, 12, 22 and a second light source 3, 13, 23, a light reflector 4, 14, 24 and a semi-reflecting mirror 5, 15, 25. The light reflector 4, 14, 24 is disposed on the upstream side of the semi-reflecting mirror 5, 15, 25 along the optical axis Ox of the output beams of the device 1,10, 20.

The device is configured so that the first source 2, 12, 22 is adapted to emit toward the semi-reflecting mirror 5, 15, 25 a first light beam 6, 16, 26 corresponding to a first predetermined statutory function of a motor vehicle light so that a first fraction 7, 17, 27 of the first beam is transmitted by the mirror at the output of the device and a second fraction 8, 18, 28 of the first beam 6, 16, 26 is reflected toward the reflector 4, 14, 24. The reflector is adapted to reflect the second fraction toward the semi-reflecting mirror 5, 15, 25 to duplicate the lighting pattern of the first light beam at the output of the device.

Said device 1 is moreover configured so that the second fraction 8, 18, 28 of the first beam 6, 16, 26 is subjected to multiple divisions into sub-fractions transmitted and reflected between the reflector 4, 14, 24 and the semi-reflecting mirror 5, 15, 25 so as to reproduce multiple times the lighting pattern of the first beam 6, 16, 26 at the output of the device 1,11,21.

The device is moreover configured so that the second source 3, 13, 23 is adapted to emit a second light beam 9, 19, 29 corresponding to a second predetermined statutory function of a motor vehicle light and oriented at the output of the device substantially along the same axis Ox as the first beam.

Moreover, when the first and second light beams are emitted simultaneously, the combination of the two beams preferably corresponds to a third predetermined statutory function of a motor vehicle light.

The semi-reflecting mirror 5, 15, 25 has a reflection coefficient of at least 5%, preferably 40%, or even 50%, and the light reflector 4, 14, 24 preferably has a reflection coefficient of at least 70%. The reflector preferably has a reflection coefficient of at least 70%.

By an “ordinary” light-emitting diode is meant a diode essentially formed of non-organic semiconductor layers. These are light-emitting diodes that are routinely commercially available nowadays, as against organic light-emitting diodes (OLED). An organic light-emitting diode generally comprises a stack of multiple organic semiconductor layers.

As shown in the FIG. 1 device 1, the first light source 2 is a point source and the second light source 3 is an area source. The point source is for example an ordinary light-emitting diode and the area source is preferably an organic light-emitting diode (OLED).

In this embodiment the rear face of the organic light-emitting diode is semi-reflecting so as to serve as the semi-reflecting mirror 5 of the device 1. The rear face is defined relative to the direction of emission of light by the diode, here along the optical axis Ox. The second or area light source 3 is arranged at the output of the device 1 so that the light beams 7, 9 that lead the device come from the area source.

In an alternative embodiment that is not shown in the FIGS., the semi-reflecting layer is formed by a coating deposited on the rear electrode of the OLED.

The device 1 further includes a light reflector 4 disposed on the upstream side of the area source relative to the axis Ox so that the reflector 4 and the second or area source 3 and therefore the semi-reflecting mirror 5 are face-to-face. They may notably be substantially parallel and centered on the same optical axis Ox. Here the reflector 4 is an “independent” element, i.e. it does not form part of one of the other elements referred to of the device 10.

A gap between the reflector 4 and the second or area light source 3 enables the first or point source 2 to emit a first light beam 6 between the reflector 4 and the second or area light source 3, in the direction of the semi-reflecting mirror 5. Here the first or point source 2 is disposed beside the reflector 4 and oriented toward the second or area light source 3.

The first light beam 6, corresponding to a first function of a light, is therefore emitted toward the semi-reflecting mirror 5 of the second or area source 3 at a particular angle of incidence. A first fraction 7 of the first beam 6 is transmitted by the semi-reflecting mirror 5 at the output of the device 1. In other words, the first fraction 7 passes through the second or area source 3.

A second fraction 8 of the first beam 6 is reflected by the semi-reflecting mirror 5 of the second or area source 3 toward the reflector 4. The second fraction 8 is reflected by the reflector 4 toward the semi-reflecting mirror 5 to be divided again by the mirror into a sub-fraction transmitted at the output of the device 1 and a sub-fraction reflected toward the reflector 5.

The lighting pattern of the first light beam 6 is therefore duplicated at the output of the device 1. Said device 1 is moreover configured so that the second fraction 8 of the first beam 6 is subjected to multiple splitting into sub-fractions transmitted and reflected between the reflector 4 and the semi-reflecting mirror 5 to reproduce multiple times the lighting pattern of the first beam 6 at the output of the device 1. The multiple repetition of the lighting pattern produces a three-dimensional effect of the lighting pattern of the first beam 6 at the output of the device 1.

Moreover, the second or area source 3 is adapted to emit a second light beam 9 corresponding to a second function of a light. The second beam 9 is oriented along substantially the same optical axis Ox as the first beam at the output of the device 1. In other words, the second or area source 3 directly emits the second light beam 9 without having to pass through the semi-reflecting mirror 5. The second or area source 3 therefore has an output face opposite the rear face through which are transmitted the fractions 7 of the first light beam 6 that pass through the second or area source 3 and through which the second light beam 9 from the second or area source 3 is emitted.

In the FIG. 2 embodiment of the device 10, the first light source 12 is an area source and the second light source 13 is a point source. The area source is preferably an organic light-emitting diode and the point source is preferably an ordinary light-emitting diode. The first or area light source 12 is disposed on the upstream side of the second or point light source 13 along the optical axis Ox.

Here the rear face of the first or area light source 12 has a reflecting layer forming the reflector 14 of the device 10. The first or area light source 12 is adapted to emit a first light beam 16 corresponding to a first function of a light.

The second or point light source 13 is adapted to emit a second light beam 19 corresponding to a second function of a light so that the second light beam 19 is oriented along substantially the same optical axis Ox as the first beam at the output of the device 10.

To this end, the device 10 includes a light guide 11 to guide the second light beam 19 from an entry face 32 to an exit face 33 of the light guide. The guide 11 has a substantially flat parallelepiped shape, for example. The point source is disposed near the entry face 32 of the guide 11, here an edge surface of the flat guide. The guide 11 also includes a semitransparent rear face defining the semi-reflecting mirror 15 of the device 10. The exit face is moreover substantially parallel to the rear face. The light guide 11 is arranged on the downstream side of the first or area light source 12 along the axis Ox so as to be face-to-face with the first light source 12. The light guide 11 and the first light source 12 are substantially parallel, for example.

The light guide preferably includes decoupling patterns on the rear face, which are not represented in the figure. The decoupling patterns serve to deflect toward the exit face the light rays of the second light beam in the guide. The second or point light source 13 therefore emits the second beam into the guide 11 via the entry face 32 and the beam is guided by reflection in the guide 11. When the rays of the light beam encounter the decoupling patterns on the rear face, they are diffused toward the exit face of the guide 11. The decoupling patterns are asperities on the rear face of the guide 11, for example.

In a manner similar to that of the first embodiment, the first light beam 16 is directed toward the semi-reflecting mirror 15 from the rear face of the light guide 11 so that a first fraction 17 of the first beam is transmitted though the guide at the output of the device 10 and a second fraction 18 of the first beam 16 is reflected toward the first or area light source 12. The reflector 14 of the first or area light source 12 reflects the second fraction 18 toward the semi-reflecting mirror 15 of the guide 11 to duplicate the lighting pattern of the first light beam 16 at the output of the device 10. Moreover, the first or area light source 12 is advantageously convex to accentuate the three-dimensional effect.

FIG. 3 shows a third embodiment of a dual-function lighting device 20 with three-dimensional effect in which the first light source 22 is a point source, for example an ordinary light-emitting diode, and the second light source 23 is an area source, preferably an organic light-emitting diode. The device 20 further includes a semi-reflecting mirror 25 arranged on the downstream side of the second or area light source 23 along an optical axis Ox. Here the semi-reflecting mirror 25 is an “independent” element, i.e. it is not part of one of the other elements referred to of the device 20. The semi-reflecting mirror 25 may be convex to accentuate the three-dimensional effect.

The second or area light source 23 and the semi-reflecting mirror 25 are spaced and face-to-face, or even substantially parallel, and centered on substantially the same optical axis Ox. The second beam 28 from the second or area light source 23 is therefore transmitted by the semi-reflecting mirror 25 along the optical axis Ox to the output of the device 20. The first or point light source 22 is here disposed beside the area source and it is oriented so as to emit the first beam 26 toward the semi-reflecting mirror 25.

Here the organic light-emitting diode includes a reflecting layer on the rear face in order to serve as the reflector 24 of the device 20 for the first light beam 26. As in the previous two embodiments, a first fraction 27 of the first beam 26 is transmitted by the semi-reflecting mirror 5 at the output of the device 20. A second fraction 28 of the first beam 26 is reflected by the semi-reflecting mirror 25 toward the reflector 24 of the second or area light source 23. The second fraction 28 is reflected by the reflector 4 toward the semi-reflecting mirror 25 to be divided again by the mirror into a sub-fraction transmitted at the output of the device 1 and a sub-fraction reflected toward the reflector 5. The first beam is therefore subjected to multiple splitting into sub-fractions transmitted and reflected between the reflector 24 and the second or area light source 23 and the semi-reflecting mirror 25 so as to reproduce multiple times the lighting pattern of the first beam at the output of the device 20.

1. A dual-function lighting device, notably for motor vehicles, comprising a first light source, and a second light source, a light reflector and a semi-reflecting mirror, said dual-function lighting device being configured so that said first light source is adapted to emit toward said semi-reflecting mirror a first light beam so that a first fraction of said first light beam is transmitted by said semi-reflecting mirror at an output of said dual-function lighting device and a second fraction of said first light beam is reflected toward said light reflector, said light reflector being adapted to reflect said second fraction toward said semi-reflecting mirror to duplicate the luminous pattern of said first light beam at said output of said dual-function lighting device, said dual-function lighting device being further configured so that a second light source is adapted to emit a second light beam oriented along substantially the same optical axis (Ox) as said first light beam at said output of said dual-function lighting device, one of said first or second light sources being an area source and the other of said first or second light sources being a substantially point -source.

2. The dual-function lighting device according to claim 1, wherein said first light source is said point source and said second light source is said area source.

3. The dual-function lighting device according to claim 2, wherein said area source is an organic light-emitting diode having a semi-reflecting area of a rear face, comprising said semi-reflecting mirror of said dual-function lighting device.

4. The dual-function lighting device according to claim 2, wherein said reflector is disposed on an upstream side of said area source, said area source being disposed at said output of said dual-function lighting device.

5. The dual-function lighting device according to claim 2, wherein said area source is an organic light-emitting diode having a reflecting layer on a rear face comprising said light reflector of said dual-function lighting device.

6. The dual-function lighting device according to claim 5, wherein said semi-reflecting mirror is arranged on a downstream side of said area source.

7. The dual-function lighting device according to claim 1, wherein said first light source is said area source and said second light source is said point source.

8. The dual-function lighting device according to claim 7, wherein said area source is an organic light-emitting diode comprising a reflecting layer on a rear face, said reflecting layer comprising said light reflector of said dual-function lighting device.

9. The dual-function lighting device according to claim 7, comprising a light guide arranged on a downstream side of said area source, said light guide having a semi-transparent rear face defining said semi-reflecting mirror of said dual-function lighting device, said light guide being configured to guide said second light beam from an entry face to an exit face of said light guide.

10. The dual-function lighting device according to claim 9, wherein said light guide comprises decoupling patterns on a rear face so as to deflect said second light beam toward said exit face, said exit face being substantially parallel to said rear face.

11. The dual-function lighting device according to claim 1, wherein said point source is a light-emitting diode with no organic layer.

12. The dual-function lighting device according to claim 1, configured so that said second fraction of said first light beam is subjected to multiple divisions in transmission and reflection between said reflector and said semi-reflecting mirror so as to reproduce multiple times the light pattern of said first light beam at said output of said dual-function lighting device.

13. The dual-function lighting device according to claim 1, wherein said semi-reflecting mirror and said light reflector are substantially parallel.

14. The dual-function lighting device according to claim 1, wherein said semi-reflecting mirror has a reflection coefficient of at least 5%, preferably 40%, or even 50%.

15. A motor vehicle light comprising a dual-function lighting device according to claim 1.

16. The dual-function lighting device according to claim 3, wherein said reflector is disposed on an upstream side of said area source, said area source being disposed at said output of said dual-function lighting device.

17. The dual-function lighting device according to claim 8, comprising a light guide arranged on a downstream side of said area source, said light guide having a semi-transparent rear face defining said semi-reflecting mirror of said dual-function lighting device, said light guide being configured to guide said second light beam from an entry face to an exit face of said light guide.

18. The dual-function lighting device according to claim 4, wherein said point source is a light-emitting diode with no organic layer.

19. The dual-function lighting device according to claim 2, configured so that said second fraction of said first light beam is subjected to multiple divisions in transmission and reflection between said reflector and said semi-reflecting mirror so as to reproduce multiple times the light pattern of said first light beam at said output of said dual-function lighting device.

20. The dual-function lighting device according to claim 2, wherein said semi-reflecting mirror and said light reflector are substantially parallel.
